(19) United States
(12) Patent Application Publication
(10) Pub. No.: US 2007/0150194 A1
(43) Pub. Date: Jun. 28, 2007

(54) Method for navigation with optical sensors, and a device utilizing the method

(76) Inventor: Gleb Chirikov, Minsk (BY)

Correspondence Address: DICKSTEIN SHAPIRO LLP, 1825 EYE STREET NW, Washington, DC, 20006-5403, US

(21) Appl. No.: 10/551,331

(22) PCT Filed: Mar. 31, 2004
(86) PCT No.: PCT/SE04/00497

§ 371 Date: Jan. 26, 2007

(30) Foreign Application Priority Data
Mar. 31, 2003 (SE) 0300913-1

(51) Int. Cl. G01C 21/00

(52) U.S. Cl. 701/220; 701/200

(57) ABSTRACT

A method for navigation and positioning with optical sensors moving over a surface. The sensors light up the surface and capture consecutive images. A reference image of a small area of the time is stored and the sensor follows said are in the sensor's filed of view by predicting where to find said area from one capture to another. The prediction is based on regression and extrapolation. When the image closing in on the edge of the sensor's field of view a new reference image is captured and stored. Before the new reference image is used as reference, the position is updated using interpolation. The navigation information is obtained with high frequency suitable for real-time applications. The invention also relates to a device using said method.

### TECHNICAL FIELD OF THE INVENTION

The present invention relates to a method for optical navigation on a surface using at least one optical sensor, especially but not necessarily related to navigating a portable printer on a print medium. The invention also relates to a device utilizing this method.

### DESCRIPTION OF RELATED ART

Hand-held and hand-operated printing devices with an inkjet print head are known through various documents.

U.S. Pat. No. 5,927,872 by Yamada (Hewlett Packard) discloses a system and a method of printing an image represented by a frame of image data utilizing a hand-held printer having optical sensor means for tracking positions of the hand-held printer relative to a surface of a print medium during a printing process. It is monitored in real time using navigation information generated by the optical sensor.

Each optical sensor comprises an array of opto-electronic elements to capture images of the surface of a print medium at fixed time intervals. Preferably, the optical sensor means can detect slight pattern variations on the print medium, such as paper fibres or illumination pattern formed by highly reflective surface features and shadowed areas between raised surface features. These features can then be used as references for determining the position and the relative movement of the hand-held printer.

In one embodiment, the hand-held printer contains a navigation processor and a printer driver. Using the printer driver, the navigation processor drives the hand-held printer to print segments of the image onto a print medium as the hand-held printer travels across the print medium to form a composite of the image.

In the international application WO 01/74598 A1, a hand-held printer in shape of a pen is shown. The printer writes on a special paper having an absolute and unique pre-printed pattern. An image sensor inside the printer records an image of the paper. The printer is adapted to convert the recorded image into at least one recorded position in the form of two coordinates. In that way, the printer always knows its exact position and is able to print an image stored in a memory inside the printer. This printer consequently needs a paper with a certain pattern to be able to operate and a processor adapted for pattern recognition.

One reason for having a pre-printed paper is that it improves and facilitates navigation and positioning of the print head and thereby also enhances the printing quality. The positioning without special paper is hence a difficult technique to master when developing hand-held printers that are swept over the print medium with hand movements, to form an image.

The printout should preferably be possible to accomplish also on any print medium and should not be restricted to any paper with a pre-printed pattern.

EP 1 283 493 A2 describes a method for tracking the motion of a pointing device using cross correlation together with auto correlation determination. In this method frame pixel data is compared one pixel at a time enabling cross correlation to be determined without the need for storing a comparison frame in a separate memory buffer, thus achieving the object of the described invention, namely to provide a tracking method requiring fewer processing cycles, and a less expensive device by the need of a single buffer memory rather than two memory arrays normally required in calculating correlation. A reference image is stored in the buffer memory and used for cross correlation with subsequent comparison frames. The velocity of related movement is used in order to predict when a subsequent comparison frame no longer overlaps the reference frame, previously stored in memory and a new reference frame is loaded. However, small steps between recapturing of reference images lead to fast accumulating errors with traveled distance and is thus more suitable for measuring velocity of movement or small displacements. The movement of the device is monitored in relation to an internal coordinate system, which coordinate system is moved and rotated as the device is moved and rotated.

U.S. Pat. No. 5,644,139 (Allen et al.) shows a scanning device and method for forming a scanned electronic image that includes using navigation information that is acquired along with image data, and then rectifying the image data based upon the navigation and image information. The navigation information is obtained in frames. The differences between consecutive frames are detected and accumulated. To avoid the accumulation of errors, the accumulated displacement value obtained from consecutive frames is updated by comparing a current frame with a much earlier frame stored in a memory and using the resulting difference as the displacement from the earlier frame. These larger displacement steps are then accumulated to determine the relative position of the scanning device.

The navigation information is acquired by means of at least one navigation sensor that detects inherent structure-related properties of the surface.

The navigation acquires sample frames with a duration of dt, where dt is chosen small enough for the scanning device not to move more than one pixel at maximum. The sensor then detects which; out of eight different possible movements to a neighbour pixel that have taken place, if any. Correlations are used to find the locations of identical features in successive frames in order to determine the displacements of the features from frame-to-frame. These correlations are called microsteps and frame rates are chosen to be sufficiently high to ensure that the displacements do not exceed the dimension of a single pixel.

To avoid errors that will accumulate during said microsteps, a sample frame is stored in a separate buffer memory. This separately stored sample frame becomes a new reference frame for a subsequent series of correlation computations, referred to as macrostep.

One basic problem faced when developing a mobile printer navigating on a printout surface is to find optical sensors with the precision or the stability needed for the navigational algorithms so to avoid smudged, uneven and otherwise distorted printouts.

It is an object of the present invention to provide a method utilising optical sensor with the level of performance needed for extreme high-speed real time applications.

It is also an object of the invention to provide method utilising at least one sensor, in which method the number of macrosteps is reduced in order to reduce the total error.

### SUMMARY OF THE INVENTION

It is an object of the present invention is to overcome the abovementioned problems by providing a method in which a navigation system is utilized including optical sensors mounted on a device in a real time process obtain a high accuracy by reducing the number of macrosteps/recaptures and further showing a technique to minimize the error given at each macrostep.

This object is achieved, according to a first aspect of the invention, by a method for navigation on a surface using at least one optical sensor comprising a image sensor, set to capture consecutive images of said surface during movement, each image being compared to a previous, the distance between the captures being accumulated in order to update the position of said sensor. Furthermore, an observation frame is stored in a memory as a reference and in a procedure of tracing the motion of this particular region of the surface around the sensor's field of view, prediction based e.g. on regression and extrapolation is used to anticipate where to find said region/observation frame at the next captured image. A number of mathematic methods for prediction is conceivable to use at this stage, however regression and extrapolation is used in a preferred embodiment.

The method for navigation in accordance with the present invention possesses high frequency, accuracy, dynamic properties and stability of operation enabling different applications such as printing, scanning or the like, where there is a need to navigate on a surface.

In a preferred embodiment two sensors are mounted on a handheld printer. The position updates then comprise an x- and a y-coordinate and an angle of rotation of the printer device.

In accordance with one embodiment of the invention, consecutive current frames are correlated with a reference frame after juxtaposition and rotation of the images. The reference image is moved around the predicted position within the current frame to find out and compare which position has the highest correlation with said current observation frame. For this correlation, the central part of the reference frame may be used, rotated an angle corresponding to an angle change since the reference frame was captured, to align rotation of the images before correlation.

In accordance with yet another embodiment of the invention, a new reference frame is captured in the field of view of the sensor as the current image approaches the edge of a sensor's field of view, or if the change of rotation angle, since the current reference frame was captured, has exceeded a predetermined threshold. To indicate when a recapture is needed, the prediction on a few frames forward of device coordinates and angle of rotation may be used. When prediction shows that a recapture is needed, the normal capture state is changed to a recapturing state. The recapture is executed simultaneously for all optical sensors, if more than one sensor is used. Normally this means that when the current stored observation frame starts to closing in at the edge of the sensor's field of view, there is a need to recapture a new observation frame to follow during subsequent captures of images.

The navigation information not obtained when capturing a new reference frame can be compensated for and the device position can be calculated by using prediction, based on extrapolation of the dynamics of the device movement. Since the only error that can occur with this technique will occur and be accumulated when shifting from a current reference frame to a new reference frame, there is a need to handle this position update with greatest care. Therefore according to yet another embodiment of the invention the new reference frame is captured and stored before it actually serves as the current reference frame. After the capture of the new reference frame, the old/current reference frame is still used for a couple of exposures in order to improve the position update which took place during the capture of the new reference frame by interpolating this value with previous and subsequent values. This is to get a more exact positioning of the sensor or the device before a switch where the new reference frame could start to act as the current reference frame.

The use of said interpolation technique at the time of recapture of a new reference frame, together with the actual following of a certain area of the surface leads to a very high accuracy in position determination. By choosing a relative large area for the sensor's field of view the number of recaptures is reduced, and by choosing a small area for the observation frame the risk of finding a secondary correlation maximum is reduced, at the same time as it entails faster calculation.

### BRIEF DESCRIPTION OF THE DRAWINGS

The features of the invention believed to be novel are set forth with particularity in the appended claims. The invention itself however, both as to organisation and method of operation, together with further objects and advantages thereof, may be best understood by reference to the following description with the accompanying drawings, in the several Figures in which:

FIG. 1 illustrates a perspective view in section of a printing device equipped with a pair of optical sensors,

FIG. 2 illustrates a perspective view from underneath of the same printing device,

FIG. 3 illustrates a block diagram describing a method for navigation using optical sensors according to the present invention and

FIG. 4 illustrates an interpolation method in an x-y-diagram.

### DETAILED DESCRIPTION OF EMBODIMENTS

In accordance with the invention, a method for navigation on an adjusted surface using at least one optical sensor with calibrated and fixed geometry is provided. The method for navigation includes navigating in an external coordinate system, fixed on a surface, by measuring X-, and Y-coordinates, along with a rotation angle of the device utilising the method. This is done in real time with a small error accumulation with travelled distance, by capturing and tracking at least two points on the adjusted surface through the field of view of the optical sensors.

In a preferred embodiment the at least one optical sensor comprises imaging optics, lightning system and an image sensor, set to capture consecutive images of the surface during fixed time intervals dt. Said surface is closed for external light and illuminated by a collimated flashing light source (red LEDs in a preferred embodiment). Images are captured by forming small moveable region of interest within image sensor's field of view, each image being compared to a previous one, and the distance between the captures being used in order to update the position of device. Furthermore, an observation frame is stored in a memory as a reference frame and in a procedure of tracing the motion of this particular region of the surface around the sensor's field of view, prediction based e.g. on regression and extrapolation is used to anticipate where to find said region/observation frame at the next captured image. A number of mathematic methods for prediction is conceivable for use at this stage, however regression and extrapolation is used in a preferred embodiment.

Every optical sensor is set to track at least one point on said surface, in case of use only one optical sensor, the field of view of sensor is split into two parts, each part used in order to track one point. The main aspect of this one sensor solution is that in this case it is not possible to obtain the positions of two points simultaneously, but only with some time delay, leading for additional calculations to align measurement in time using knowledge about device dynamic, and this therefore increases the error of the method. However, a less expensive device can be provided, in which only one sensor is used.

The high accuracy of the method is achieved by the use of image sensors of enough big size (360×300 pixels in a preferred embodiment) to be able to track points of surface on a significant distance and by introducing tele-centrical imaging and lighting optics to reduce changes of light (e.g. shadows) and imaging condition while tracking though field. High accuracy also is achieved due to special procedure of calibrating distortion and geometry of optical sensors with a subpixel precision (0.2 pixel in a preferred embodiment), subpixel interpolation of cross-correlation and special procedure for recapturing tracking points on surface.

High frequency of obtained navigation information, needed for real time application, is achieved by using small sized observed windows (24×24 pixels), used in order to reduce the time required for obtaining images from sensor and image processing. This window is able to capture images of tracking points everywhere within a big field of view. Furthermore, prediction of window's position within the image sensor used, is based on prediction of device position built on movement history, which allow a reduced search region to find maximum correlation, corresponding to new image location. Choosing a small region for finding cross correlation maximum (±2 pixels around predicted position or total 5×5 pixels) entails faster calculation and at the same time reduces the risk of finding a secondary correlation maximum, especially if adjusted surface has regular structures. The size of observed window 24×24 pixels chosen in preferred embodiment, but small variations are possible depending of the spatial frequency of the surface structure and imaging optics scale factor and resolution.

Stability of navigation method is achieved by introducing an error handling state machine, allowing to recognize and handle error situations, for example when invalid navigation information is obtained, and then initiate fast recapturing to capture a new reference point on surface if navigation has been lost. The adequacy of image structure quality is analyzed and used to solve the situation when it is not possible to navigate of the reason that the surface has not enough structure or if the device is lifted up from surface.

As an example of a real-time application, a printer device may print on a surface in fixed distance intervals, when travelled through a virtual grid, corresponding to a printing resolution. If the printer does not print a dot at a place where it should print, the dot will be distorted from its place and thus affect the printing quality. Since the coordinates of the printer is function of time, the printer device require coordinate information (X, Y, angle) as a function of time, where time is the same important factor for navigation precision. With a printing resolution of 600 dpi and a maximum speed of printing up to 400 mm/s the coordinates should be determinate in time at least with ±50 μs. However, navigation information is updated with some fixed time intervals and with some time delay, as information can be obtained only after captured images have been processed. This means that information about the current position of the device always is an extrapolation of coordinates data from the past. Also, the printing application have to predict coordinates forward in time to calculate when the printhead will pass the virtual grid and prepare information to be printed on a printout media.

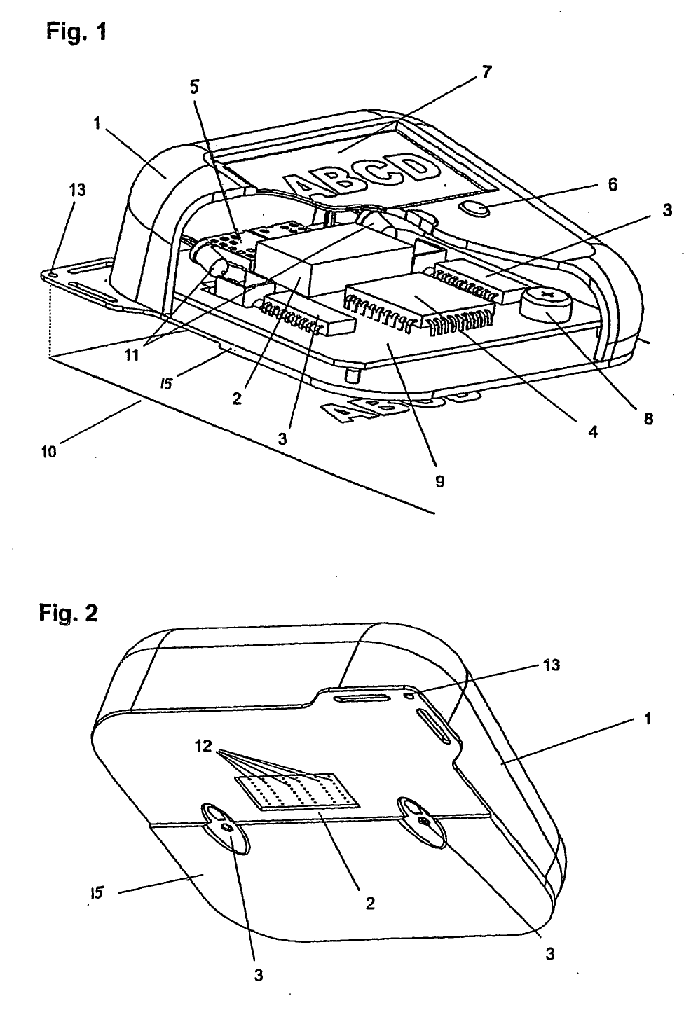

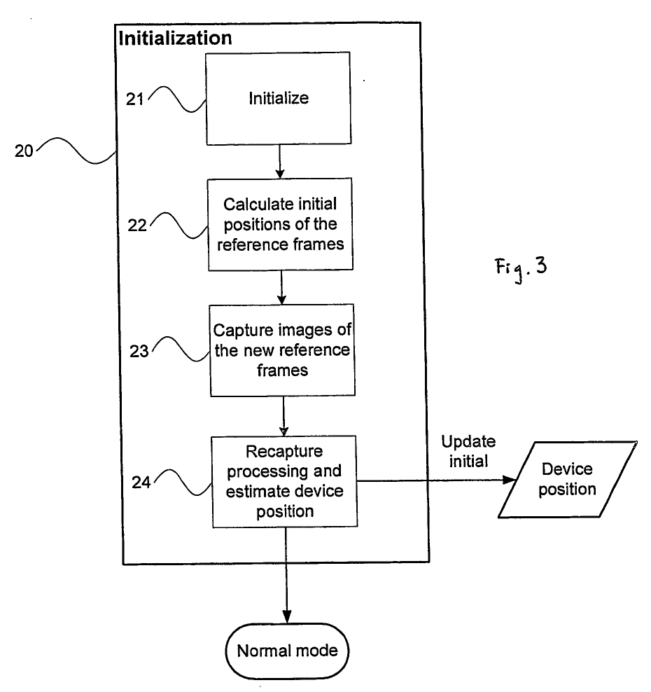

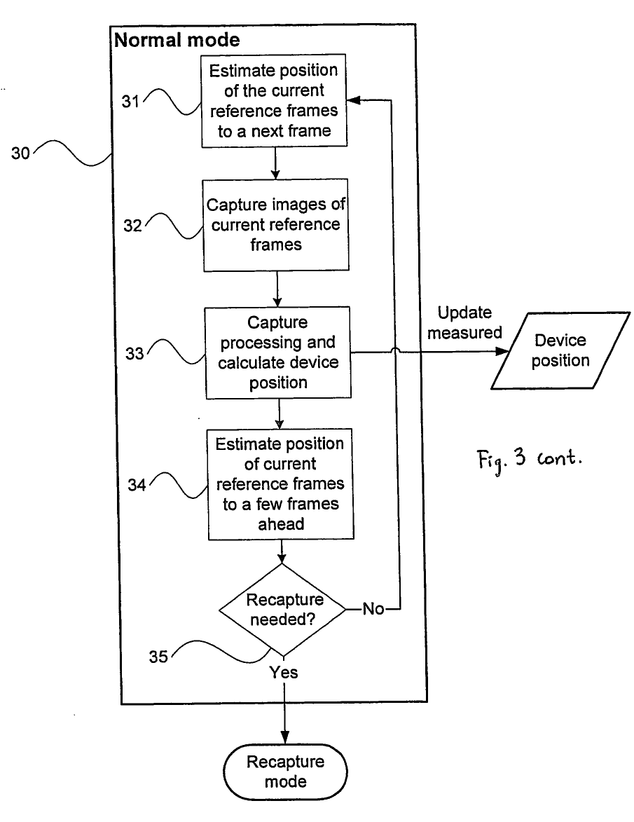

Referring now in detail to the drawings and initially to FIGS. 1 and 2, there is shown a mobile printer equipped with a pair of optical sensors 3 with an inkjet head 2 designed to provide a compact portable printing device in order to enable a user to print from small portable devices such as a cellular phone, a portable PC, a personal digital assistance (PDA) or the like, and other portable electronic devices or for electronic stamping, printing of small texts, tags, addresses, cutting and clipping. By fixing a print-head in a construction plate 9 where one or more positioning sensor means are fixed as well, it is possible to obtain a geometrical construction with an x- and y-coordinate system and to establish, with great mathematical accuracy, the coordinates x and y for each individual ink-jet opening/nozzle in the print-head.

The coordinates, during a time frame, constitute the grounds for an accurate and precise spraying of ink-drops onto a printing surface according to a predetermined printing design.

Regarding the terminology used, images of a surface are obtained by observation frames within a big field of view. Depending on the purpose, the observation frame may be interpreted as a reference frame, to be stored in the memory, or as a current frame.

FIGS. 1 and 2 illustrates a hand operated printing device composed by a construction/design body 1 and a print-head 2 which interact with one or more optical positioning sensor means 3, a micro controller circuit 4, a communication unit 5 to transmit the data, one or more command buttons 6, a control screen, and a source of energy, in this case a battery 8. The mobile printer and its features will not further be described since the present invention focuses merely on the optical sensors. However, the functionality of the mobile printer is thoroughly described in the International Publication WO 03/006244 from the same applicant and hereby incorporated by reference.

The optical sensors in a printer device such as above consequently needs to be very accurate and the hardware/software controlling the navigation needs to have a very high real time performance in order to process the navigation information and thereafter send commands to the printhead.

An optical sensor, herein described, is therefore developed to meet this requirement. It is to be noted that the optical sensor shown is not limited to a printing device (hereafter called “the device”), but could naturally be used in all possible applications in all types of devices where an accurate navigation on any surface is needed.

However, in the preferred embodiment with the mobile printer device, two sensors are needed to take account for a possible rotation of the device during a print out sweep by a user. A user that moves the printer over any printout surface tends to form a rotating movement around his elbow. It is though to be understood that the method of navigation by optical sensors described herein is not limited to the use of exactly two sensors, but will also function with a single sensor or a larger number of sensors.

The invention will not deal with the physical construction of the sensor, but rather software based methods for navigation on a surface. This application is therefore not limited to any special type of optical sensors. However, in an environment where the device carrying the sensors according to the invention is a mobile printer, a telecentric lens would be preferred since that makes the sensor more insensitive to vertical variations on the printing surface.

The navigation procedure envisaged is as follows: A CMOS matrix of 640×480 pixels, which provides a field of view of 360×360 pixels, is used in a preferred embodiment for each of the two sensors.

Initially reference frames are captured in the respective centres of both sensors' field of view. A frame is an image of 24×24 pixels and will from here be called the “observation frame”. The size of the CMOS matrix and the observation frame could of course be chosen differently, but in this example these will be the sizes used. As was mentioned earlier, depending on the purpose an observation frame may be interpreted as a reference frame, to be stored in a memory, or as current frame, to be correlated with a reference frame. Reference frames can in turn be a new reference frame or a current reference frame (hereinafter—reference frame). Only current reference frames are used for correlation with consecutive current observation frames. New reference frames are used within some navigation state (e.g. a recapture procedure), when there is a need to store new captured reference images in parallel with current reference image before a new reference will become a current reference frame.

As a device with the sensors mounted on is moved around the surface, subsequent images are captured at equal time intervals dt. The distances covered between the moment the reference frame was captured and the moment of the latest captured image in both sensors, together with the angle between the two radius vectors, yield the position and the orientation of the device at every exposure. This is the so-called normal capture procedure, described further below.

From time to time there is a need to capture a new reference frame, the so-called recapture procedure, also described below.

Normal capture: Normal capture is the procedure of tracing the motion of a particular region of the paper surface around a sensor's field of view (here 640×480 pixels, but can of course have other dimensions) between sequential exposures. The reference observation frame is preferably but not necessary captured in the centre of the field. Each observation frame is in the preferred embodiment 24×24 pixels and in the worst case (motion in one direction along the short side of the field view) there will be at least dozens of normal captures until the current image reaches the edge of the field and a recapture of a new reference observation frame is needed.

Note that each normal capture and the associated distance calculation are independent, so there is no error accumulation during this stage.

The distances covered between the moment the reference frame was captured and the moment of the latest captured image is obtained using a procedure of correlation analysis of images.

It is predicted by a correlation function where to find said particular region between two observation frames by taking images at this predicted position, based upon regression and extrapolation of previous values of x, y and theta, where theta is the angle for the device. Stated another way, the prediction of the position of the device is based on polynomial regression of the history of the device positions and then extrapolation in time. The regression of a second order is used in a preferred embodiment. Coordinates X-, Y- and rotation angle are regressed on time scale independently. Coefficients of regression are updated every frame, if valid navigation information is obtained. Not valid navigation data, if the case, or data, that has been calculated by extrapolation, are not used in a regression update. The distance between two consecutive observation frames is naturally dependent on the capture frequency, speed and acceleration of the device, but also of any possible rotation.

The distance could in this preferred embodiment be several pixels. Having an adequate correlation function predicting where to find the current observation frame from one exposure to the other, means that the capture frequency does not have to be so high that the maximum allowed distance of movement between two captures has to be maximum one pixel as in the prior art. A correct correlation function will “find” the particular region even though the distance might be several pixels. This is due to the nature of a sweeping movement by a human hand that cannot alter the acceleration or rotation notably between two successive captures.

Since observation window follow for reference place on surface on a long distance though field, there is possible significant variations of lightning level and some changes of image quality, as difficult to produce perfect illumination and imaging optical solution within wide field from close distance. In this case reliable result give only advance correlation with normalizing. A simple method of correlation, like accumulation of images differences, used in EP 1 283 493 A2 application, will not be successful.

An example of a regression formula that could be used is as follows:

$${R}_{S} ( ⅈ , j ) := \frac{{\sum }_{m = 1}^{M} {\sum }_{n = 1}^{N} {A}_{m , n} \cdot {B}_{m + i , n + j}}{{[ {\sum }_{m = 1}^{M} {\sum }_{n = 1}^{N} {( {A}_{m , n} )}^{2} ]}^{0.5} \cdot {[ {\sum }_{m = 1}^{M} {\sum }_{n = 1}^{N} {( {B}_{m + i , n + j} )}^{2} ]}^{0.5}}$$

Since prediction is used in order to follow a reference place on a surface, the observation window is placed as close as possible to the predicted position (with a step size, which allow SMOS-sensor) and allows a reduced search region to find the maximum correlation, corresponding to the new image location. Choosing a small region for finding cross correlation extremes (±2 pixels around predicted position or a total of 5×5 pixels) entails faster calculation and at the same time reduces the risk of finding a secondary correlation maximum, especially if adjusted surface has a regular surface structure. However, prediction has some error from noise and device acceleration reasons. If this error will exceed 2.5 pixels, the correlation will not find the absolute maximum and navigation update for this frame will fault.

In accordance with one embodiment of the invention, consecutive current frames are correlated with a reference frame after juxtaposition and rotation of the images. In a preferred embodiment for correlation is used the central part of reference frame 14×14 pixels, rotated on angle, corresponding for angle change since reference frame was captured, to align rotation of the images before correlation. This reference image is moved around the predicted position within current frame 24×24 pixels to find out and compare which position has the highest correlation with said observation frame.

Each new image is compared to the reference image by correlating the new image with the reference image at a number of positions around the predicted position to find out which position has the highest correlation. In a preferred embodiment the maximum of the correlation function is determined by moving the central pixel region of the 24×24 pixel observation frame around the predicted position, after juxtaposition and rotating the two images, to find out which position has the highest correlation. Choosing such a small observation frame as 24×24 pixels is advantageous e.g. for avoiding to find a secondary maximum.

The most likely position of the maximum is hence predicted from the history to determine the velocity and direction of the device. The error of the prediction consists of the regression error and the error due to acceleration of the device during the interval between exposures. This central pixel region of the observation frame, referred to as the “central observation frame area”, could of course vary according to any suitable size, but as an example, a 14×14 central observation frame area could be suitable in a 24×24 pixel observation frame.

To complete the analysis one needs to consider the effects of rotation on the correlation function. Rotation in general is a problem, because the light source rotates together with the device, and so do the shadows and the lit spots on the surface of the paper. However, it is immediately clear that rotation is very small between subsequent exposures. A rotation of one degree between exposures at preferred frequency would correspond to about three full rotations/second and that is not a likely speed of rotation expected from the normal user.

Nevertheless, to take proper account of rotation the reference image is rotated before juxtaposition with the current frame. This could be achieved using the following procedure: When the new reference image is captured there is nothing to correlate it with, so the extra cycles are spent on adding some more points to the image by two dimensional interpolation of reference image by bi-cubic spline. The actual reference matrix could e.g. contain three times as many points as the normal 24×24 observation frame; let's say a 70×70 frame. When needed, the central observation frame area is rotated and the brightness function is interpolated from the 70×70 matrix. This interpolated image is used for a fast rotation procedure by extraction of nearest values to empty rotated grid of 14×14 pixels.

Recapture: When the current image approaches the edge of a sensor's field of view, a new reference frame is captured in the field of view of the sensor. This will happen e.g. when the device has moved too far from the stored current/old observation frame or when the rotation of the device has changed more than a predetermined threshold. New reference images are preferably taken for the two sensors simultaneously for symmetrical reasons.

The motion history could be used for analysing and predicting the most advantageous (from the point of view of the longest time to next recapture) position for the new observation frame. This should normally be at the edge of the sensors view so the reference frame could travel through the whole area of the sensor before next recapture must take place. The goal must of course be to reduce the number of recaptures to minimise accumulated errors. In situations when it is not possible to predict the direction of movement (e.g. in the initial point, when navigation starts) a new reference frame should be captured in centres of field.

When a new observation frame is captured it is preferable to use the old/current reference observation frame for a couple of more exposures to make position prediction more accurate after the system switches to the new reference. This will be described more thorough later.

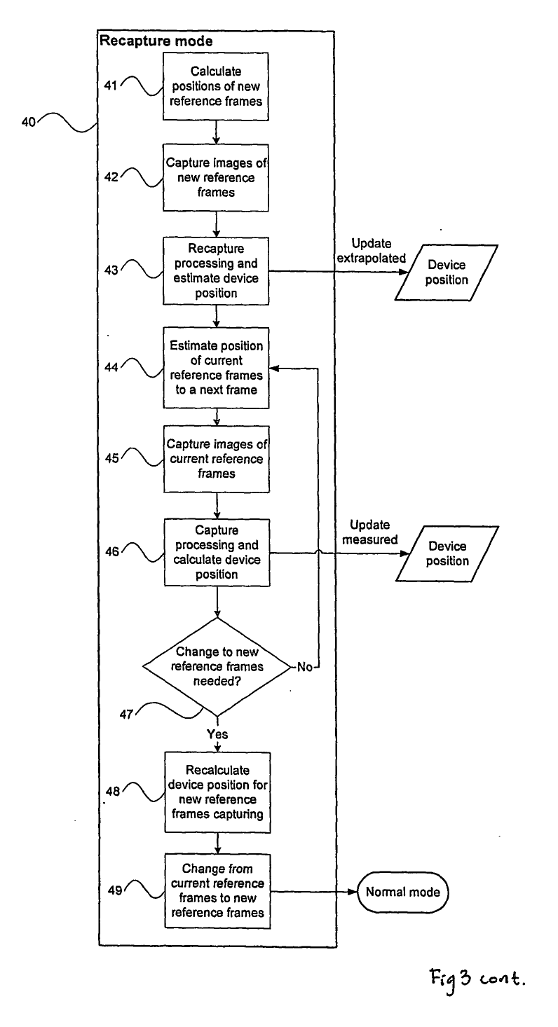

FIG. 3. illustrates an embodiment of a navigation algorithm diagram for software in combination with an optical sensor according to the invention.

Initially when placing the device comprising sensors according to the invention on a surface an initialisation procedure 20 takes place as seen in blocks 21-24. The system will understand that the there is no movement since the initial exposures will be taken on exact the same spot. All variables could then be set to zero. As soon as the surface starts to move with respect to the sensor, the normal mode 30 is entered.

The normal mode 30 of capturing frames where the major task of navigation is carried out, i.e. to produce the “current” coordinates (x,y) and the rotation angle (theta) for the device is illustrated in 31-35. This is done by taking images 32 at a predicted position, to find the pattern of the current reference frame, the position being based upon regression and extrapolation of previous values of x,y and theta 31. An update of the device position is hereby obtained 33 after each image capturing by accumulating the x-, and y-coordinates.

In order to predict when we are closing in on the outer boundaries of the field of view of the sensor a position of the current observation frame a couple of frames ahead is calculated 34 to see if a recapture is needed 35. The exact number of frames ahead used, is of course optional and could be set for each individual use.

In an alternative embodiment, the condition for a recapture could be set to be initialised when the observation frame is closing in to a predefined area of the sensor (rather than the edge of the sensor), which is not reliable in terms of having perfect optical properties. This is advantageous when having a sensor with inbuilt irregularities where, e.g. only the central part of the sensor is reliable in optical performance due to e.g. an imperfect lens.

The recapture process 40 starts with an estimation of the next position 41 of the device by extrapolation from previous positions and initiating the sensor to capture and store a new reference frame somewhere in the sensor's field of view at that predicted position 42. Said new reference frame could be chosen as said at an edge of the sensor's field of view or in any other place within sensor's limits, e.g. at the centre.

From a hardware point of view the new reference images/observation frames are captured and stored in a dedicated buffer, i.e. in a buffer that is not the “current” buffer. Note that the current reference images/observation frames remain unchanged at this point, and will be used at a few more captures. The exact number of times is of course optional. Said technique is used since the problem with the new reference frame is that its exact location is not known; instead it can only be extrapolated from previous positions. Therefore to make a better estimate of the exact location of the new observation frame, the current reference frame is used to get a few more positions.

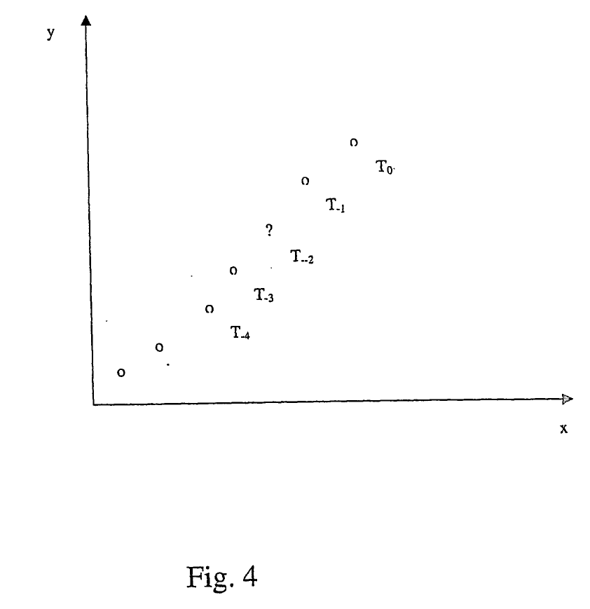

As can be seen this technique is visualized in FIG. 4. an example is given where no exact position for the time when the new reference frame was taken (T₋₂), since in this example that clock cycle is occupied with capturing the new reference frame. In the next clock cycle the current observation frame is again searched for and when it is found this position update could be used together with later and earlier position updates to interpolate and get a better position update for the device's position during the “lost” clock cycle while the new reference frame was taken.

Consequently, in order to make a more exact determination of the new reference image position, interpolation is used, based on the positions surrounding it, i.e. (T₀, T₋₁, T₋₃, T₋₄ etc). Once this calculation has been done and when the system decides that a change to the new reference frame is needed, the current reference frame is replaced by the new reference frame. Hence, the new reference frame will now serve as the current reference frame.

By going back to FIG. 2 we see the same thing described above in the block diagram where frame 44-47 describes the interpolation procedure with a loop where it is obvious that the current reference frame still is used until a change is needed, even though a new reference frame has already been captured and stored. The switch from the current reference frame to the new reference frame then takes place 49 when the device position has been recalculated 48 and the algorithm controls the sensors back to normal capture mode 30. This mode is then continued until the new reference frame closes in to the outer limit of the sensor's field of view or until the rotation exceeds the predefined threshold.

Fast recapture: The navigation information, obtained from every correlation, can be appreciated as “valid” or “not valid”. For appreciation of navigation information as valid or not, the level of correlation maximum together with the checking of the position of correlation maximum is used. If the result of the correlation is “not valid”, the navigation information is updated by extrapolation. However, prediction has some error from noise and device acceleration reasons. If this error will exceed 2.5 pixels, the correlation will not find the absolute maximum and navigation will obtaine “not valid” data. If this will happened twice, that is, in consecutive frames, this means that navigation probably will be lost for reference points on the surface, and there is a need to recapture next frame (i.e. Fast recapturing state), keeping navigation dynamics (speed, accelerations for X-, Y- and angle), and using this dynamics to try to continue navigation process. Fast recapture can accumulate significant error (like small jumps on navigation area), but it improves stability of navigation in some situations.

If the navigation was not capable to determine the position of the last captured image, i.e. the correlation function failed to find the observation frame, a new reference frame is captured and is used at once without the sub-states handling and interpolation that is done according to previous paragraphs. In this case the position of the new reference frame is set at the estimated position through regression from the history of the previously known positions.

It is preferable to calibrate the optics before using it in the sensor in order to obtain a higher precision and reduce distortion due to imperfectness of the optics. Hence, by using calibration data to compensate for non-perfect optics confer a higher precision of the navigation.

In summary, the present invention works by “locking up” at least two small targets on a surface by a reference image frame (e.g. 24×24 pixels) within a larger dynamic moving image frame (e.g. 300×300 pixels). Relative to the coordinate system from the navigation surface these small reference image frames are “fixed” on a surface. Relative to the coordinate system from the device utilizing the present method, and if the device is moving relative to the navigation surface, these images are dynamic.

It can thereby be said that the present inventive method is an absolute navigation system while the small reference image frame is found within the boundaries of the larger image frame. Every time the small frames leave the larger one, another small frame is chosen in the large frame. This is called the “recapture procedure” described earlier and is the relative part of the navigation system. This is the part where error deviations are primarily generated. In comparison to other systems these are minimised by means of the present invention, and the accuracy is thereby greatly improved.

The prediction module of the present system is a feature that uses a polynomial regression function to help predict where the next observation frame should be “ordered” in order for the original source (being for example a microstructure feature of the navigation surface) to be found within that frame with a very high probability. A failure to find the original source would trigger a fast recapture procedure. Another feature that reduces the accumulation of errors is the angle feedback used previous to a correlation function in order to adjust images by interpolation and compensate for rotation of the device utilising the method.

By means of the method in accordance with the present invention, a very accurate navigation of a device on any surface that is flat enough and having a microstructure or micro-relief with high frequency of navigation information update, suitable for real-time applications, is achieved. In certain applications, such as printing applications, this is very important as even very small errors can be perceived by the human eye. Thus, if the navigation method used is even the slightest inaccurate, the ink droplets ejected by the print head will be misplaced and the result of the printout will not be satisfactory. Using reference observation frames within a large field of view (for example the sensor's field of view) increases the accuracy of the method many times over.

In the exemplary embodiments of the description use of two sensors has been assumed. It is however possible to use a single sensor having a large field of view. The single sensor would then take pictures of two different parts of the printout surface in an alternating manner. The processing would thus be somewhat more complicated and the printer, when used in such application, slightly slower.

1. A method for navigation on a surface using at least one optical sensor comprising an image sensor set to capture consecutive images of said surface during movement, each image being compared to a current reference frame, the distance between the captures being accumulated in order to update the position of said sensor, characterized in that an observation frame is stored in a memory as a reference and that each subsequent image is compared with a current reference frame in a procedure of tracing the motion of a particular region of the surface around said image sensor's field of view between sequential exposures, finding said particular region at each exposure by taking images at a predicted position, wherein said predicted position is identified by means of at least a horizontal and a vertical coordinate and a rotation angle.

2. Method for navigation on a surface according to claim 1, characterized in that said optical sensor(s) are mounted on a handheld printer device and that said coordinates and rotation angle defines the displacement and rotation, respectively, of said device.

3. Method for navigation on a surface according to claim 2, characterized in that the rotation angle is determined by using two different positions on the surface with some distance between them, said two positions being observed and traced within at least one big area optical sensor, or smaller optical sensors with well known geometry, to get said angle of rotation.

4. Method for navigation on a surface according to claim 1, characterized in that each new captured image is compared to said current reference frame after juxtaposition and rotation of the images.

5. Method for navigation on a surface according to claim 1, characterized in that each new image is compared to said current reference frame by correlating the new image with the current reference frame at a number of positions around the predicted position to find out which position has the highest correlation.

6. Method for navigation on a surface according to claim 5, characterized in that new reference frames are captured in such places of field of view which provides the longest prediction distance of the device travelling without recapturing.

7. A method for navigation on a surface according to claim 6, characterized in that a new reference frame is captured in the field of view of the sensor as the captured images approaches the edge of a sensor's field of view or if the rotation angle has exceeded a predetermined threshold.

8. A method for navigation on a surface according to claim 6, characterized in that the new reference frame is captured at that edge of the field of view of the sensor which provides the longest predicted elapsed time to when next recapture must be done.

9. A method for navigation on a surface according to claim 5, characterized in that the new reference frame is captured in the centre of the sensor's field of view.

10. A method for navigation on a surface according to claim 5, characterized in that the current reference frame serves as reference observation frame for one or a few additional exposures after a new reference frame has been captured and stored.

11. A method for navigation on a surface according to claim 10, characterized in that the position is estimated by extrapolation from earlier position updates as said new reference observation frame is captured and that subsequently during said few additional exposures the position is determined and updated by interpolation based on position updates before and after the moment the new reference frame was captured; thereafter the new reference frame is allowed to serve as current reference frame.

12. A method for navigation on a surface according to claim 5, characterized in that a new reference frame is captured and used as current reference frame immediately for the following frames, if the position determination for the last two consecutive captured images fail.

13. A device navigating on a surface by using at least one optical sensor comprising an image sensor set to capture consecutive images of said surface during movement, each image being compared to a previous, the distance between the captures being accumulated in order to update the position of said sensor, characterized in that said device comprises a memory in which an observation frame is stored as a reference image and that said device is arranged to compare each subsequent image with a current reference frame in a procedure of tracing the motion of a particular region of the surface around said image sensor's field of view between sequential exposures, finding said particular region at each exposure by taking images at a predicted position, wherein said predicted position is identified by means of at least a horizontal and a vertical coordinate and a rotation angle.
